(19) United States
(12) Patent Application Publication
(10) Pub. No.: US 2024/0075711 A1
(43) Pub. Date: Mar. 7, 2024

(54) INDUCTION BOARD FOR ADHERED ROOFING SYSTEM

(71) Applicant: Holcim Solutions and Products US, LLC, Nashville, TN (US)

(72) Inventor: Crint LaBrosse, Bay City, MI (US)

(21) Appl. No.: 18/242,117

(22) Filed: Sep. 5, 2023

Related U.S. Application Data
(60) Provisional application No. 63/403,889, filed on Sep. 6, 2022.

(51) Int. Cl. B32B 15/02; B32B 7/12; B32B 15/08; B32B 27/28; E04D 5/14; E04D 11/02

(52) U.S. Cl. CPC B32B 15/02; B32B 7/12; B32B 15/08; B32B 27/28; E04D 5/149; E04D 11/02; B32B 2255/06; B32B 2272/00; B32B 2307/304; B32B 2419/06

(57) ABSTRACT

An induction board for use in a roof system. The induction board includes a base and an adhesive covering the base or a portion of the base. Metal wire which may in the form of a metal wire mesh, is coated with the adhesive and disposed over the base. The metal wire may be used as a susceptor in an induction heating process. The roof system also includes a roof deck on top of which the induction board is secured and a membrane over the induction board. The adhesive activates with the addition of heat created during the induction heating process to adhere all or part of the membrane with the induction board.

### TECHNICAL FIELD

The present application relates to an induction board for an adhered roofing system and to the adhered roofing system.

### BACKGROUND

Low slope roofing systems are used to, inter alia, cover and waterproof a roof. Low slope roofing systems are secured to the roof and commonly include insulation that is covered with a coverboard and a membrane to help weatherproof the roof. In some applications, the membrane may comprise PVC (polyvinyl chloride), TPO (thermoplastic polyolefin or EPDM (Ethylene Propylene Diene Terpolymer). The membranes are typically secured to the roof by mechanical fasteners. Such fasteners provide discrete points at which the membrane is secured. When a mechanical fastener is used, the membrane is typically laid in an overlapping fashion such that the fasteners can be covered by a portion of an adjacent section of the membrane. The overlapping portion may then be secured to the adjacent membrane such as by welding or by the use of adhesives.

Alternatively current membranes may be secured to the roof, or a coverboard, by the use of an adhesive. This may result in a fully adhered roof system. In such systems the membrane is adhered to the roof deck or coverboard using water based, solvent based or urethane adhesives. These materials are applied as a liquid by spraying or paint type roller applications. While these methods are effective to fully adhere the roofs they do require a relatively substantial amount of time and labor. These systems, when being placed on a roof, are also subject to weather conditions. For example, temperature and humidity each play a role in the ability to even apply a fully adhered roof of this type or the amount of cure time necessary for the adhesive. Further, the adhesive has to cure on the roof after the application of the adhesive and placement of the membrane. In addition, once the membrane is laid onto the adhesive it is relatively difficult to adjust its position.

Yet another type of system used to secure roofing membranes is known as the RhinoBond® System and is available from Sika Sarnafil. This system uses discrete mechanical fasteners at spaced intervals to hold down a coverboard. The mechanical fasteners are coated with a material to which the roofing membrane is fused. This system uses induction to fuse the membrane to the mechanically fastened the membrane to each plate This system is not fully adhered and the membrane is secured to the roof deck at spaced intervals. The system uses an induction power unit and a stationary iron that heats the plate and fuses or adheres the membrane to the coating on the fastener.

In many applications, it would be desirable to be able to provide a fully adhered system without the need to apply adhesive on site and then secure the membrane over the uncured adhesive.

### SUMMARY

In an embodiment, there is provided an induction board for use in a roofing application comprising a base material and metal wire disposed over the base material. The metal wire is configured to act as a susceptor for an induction welding process. The induction board further comprises adhesive disposed over the base material, wherein the metal wire is coated with the adhesive and wherein the adhesive is thermally activated.

In an embodiment, there is provided a roof system comprising an induction board secured to a roof deck comprising a base material and metal wire configured to act as a susceptor disposed over the base material. The roofing system further comprises an adhesive disposed over the base material, wherein the metal wire is coated with a thermally activated adhesive. The roofing system further comprises a membrane disposed over the induction board, wherein the membrane is adhered to the base by the thermally activated adhesive.

### BRIEF DESCRIPTION OF THE DRAWINGS

FIG. 1 is cross sectional view of an induction board in accordance with an embodiment; and

FIG. 2 is a cross-sectional view of a roofing system in accordance with an embodiment.

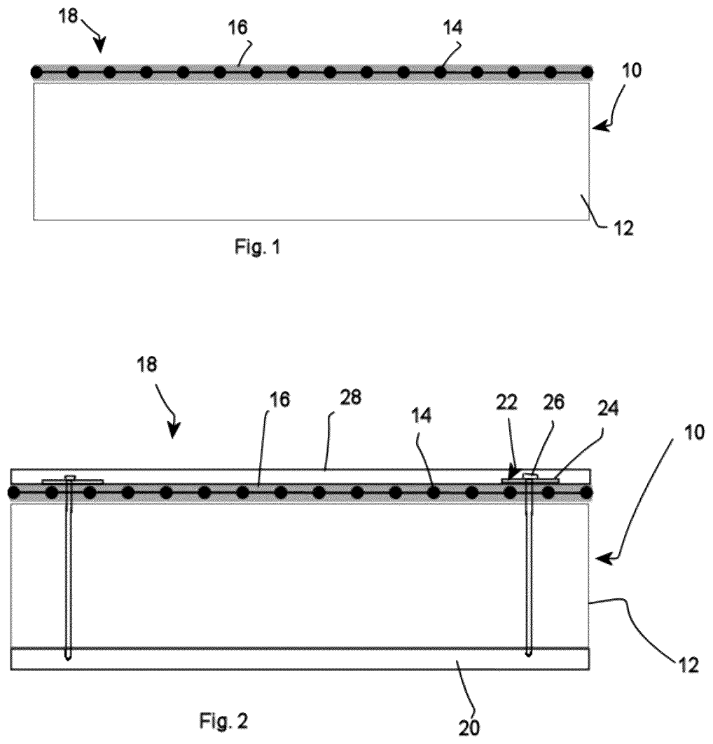

### DETAILED DESCRIPTION

An induction board adapted for use on a roof is generally shown at 10 in the Figures. The induction board 10 comprises a base 12, metal wire 14 and an adhesive 16. In an embodiment, the metal wire 14 is coated with the adhesive 16. “Coated,” as used in connection with the adhesive 16 over the metal wire 14, means that the metal wire is either fully coated or partially coated. Further, metal wire as used herein means any suitable metal material that can be used in conjunction with the adhesive 16 and base 12 in order to permit inductive heating of the metal wire 14 as further discussed below.

The base 12 can comprise any suitable material, and may be rigid or semi-rigid. In an embodiment, the base 12 comprises a coverboard. Commonly available coverboards comprise fiberglass mat-faced gypsum, fiber reinforced gypsum, perlite, OSB and plywood. Less commonly, high density insulating panels (compressed polyisocyanurate core with coated glass mat facers. Available coverboards also comprise plastics, cellulose and various combinations of all of the aforementioned materials. In an embodiment, the materials used for such coverboards may also include recycled cellulose and plastic materials. Some coverboards that may be used and comprised of the above materials include, DensDeck® offered by Georgia Pacific Gypsum, Securock® Gypsum-Fiber Roof Board offered by USG Corporation of Chicago, Illinois, Everboard t m Composite Roof Cover Board offered by Continuus Materials of The Woodlands, Texas, and Dexcell® Roof Board offered by Nathional Gypsum Company of Charlott, NC. The coverboard may have a thickness of one half of an inch to an inch. In an embodiment, the coverboard comprises recycled coverboard. It will be appreciated, however, that the thickness of the coverboard may vary, and any suitable thickness may be use.

In other embodiments, the base 12 may comprise rigid or semi-rigid insulation. By way of example, the base 12 may comprise high density or standard density polyisocyanurate insulation. One suitable polyisocyanurate insulation is Duro-Guard® offered by Duro-Last, Inc. of Saginaw, MI. The polyisocyanurate may have a thickness of one half of an inch to six inches. It will be appreciated, however, that the thickness of the insulation may vary, and any suitable thickness may be use. In an embodiment, the base 12 may comprise a combination of coverboard and insulation.

As stated earlier, the induction board 10 includes metal wire 14. In some embodiments, the metal wire 14 comprises metal wire mesh, as shown in the Figures. The metal wire 14 of the induction board 10 is adapted to be used as a susceptor in an induction heating process. This process is also may be referred to herein as induction welding. In an embodiment, the metal wire mesh may come in segments. By way of example the metal wire mesh segment may be 24 inches by 24 inches. The metal wire within the metal wire mesh may comprise any suitable diameter. By way of example the metal wire may have a diameter of 0.014 inches. It will be appreciated that the sizes for the metal wire mesh may take any size and shape that allows for the placement of the metal wire 14 mesh on a top surface of the base 12 and under a membrane 28 as discussed below.

The induction board 10 further comprises an adhesive 16. In an embodiment, the adhesive 16 is thermally activated. In an embodiment, the adhesive 16 is stable from subzero temperatures to at least 150° F. The adhesive 16 will not activate within this temperature range, and will allow for its activation by introduction of heat above the activation temperature of the adhesive. It will be appreciated that in other embodiments, the temperature range for adhesive stability 16 may vary.

The adhesive 14 is used to coat the metal wire 14. In an embodiment, the metal wire 16 is dip coated in the adhesive 16 and dried. The adhesive 14 may fill all or a portion of the openings in the wire mesh to produce a solid substrate. The coated metal wire 14 is placed on the base 12. In an embodiment, the solid substrate produced can be used as a facer for the base 12. In an embodiment the solid substrate is used as a facer for a high density polyisocyanurate insulation base 12.

In an embodiment, the adhesive 16 can be laminated onto the base 12. In this embodiment, the metal wire 14 is place on the base 12 and may be pressed on the base 12. The adhesive 16 is then applied onto the metal wire 14 and base 12, such that it covers the metal wire 14. Once the adhesive 16 has coated the wire 14 and is on the base 12, it will not activate until its activating temperature is reached.

The induction board 10 is adapted to be used in a roof system generally indicated at 10. The roof system comprises the induction board 10 having the base 12, the metal wire 14 and the adhesive 16 thereon. The induction board 10 is adapted to be placed on a roof deck 20. In an embodiment as shown in FIG. 2, the induction board is secured to the roof deck by suitable fasteners generally shown at 22. The fasteners 22 may comprise a plate 24 and a screw 26. The plate 24 may comprise a load distribution plate having an opening therethrough which are well-known in the industry. The screw extends through the hole in the plate 24 and into the roof deck 20.

A membrane 28 is disposed over the induction board 10 and the fasteners 22. The membrane 28 may comprise any suitable membrane used to help weatherproof a roof. In an embodiment the membrane 28 comprises a PVC membrane which may also include a scrim therein. In another embodiment, the membrane may comprise a TPO membrane which may also include a scrim therein.

In order to assemble a roof system 18 according to an embodiment, induction boards 10 comprising the base 12, metal wire 14 and adhesive 16 are fastened to the roof deck 20 using the fasteners 22. The membrane 28 is then placed over the induction board 10 and particularly over the adhesive 16 and fasteners 22. The membrane 28 can be moved relatively easily until it is the proper position, which may provide greater flexibility in locating the membrane 28 in a desired location or orientation. Once the membrane 28 is situated, the metal wire 14 can act as a susceptor during an electromagnetic induction heating process. As the metal wire 14 is heated, it, in turn heats the adhesive 16 to a temperature at which the adhesive 16 will activate. The adhesive, in turn adheres the membrane with the induction board 10 which is secured to the roof deck 20. Further the membrane 28 may also be heated in the process of induction heating of the adhesive which may allow greater adhesion of the membrane to the induction board 10.

In an embodiment, the roof system 18 can be used to fully adhere the membrane 28 with the induction board 10. This may be advantageous particularly where the roof is subject to high wind uplift. It will be appreciated that as used herein, a fully adhered roof may have areas where the membrane 28 is not fused to the induction board 10. Such areas may be relatively small compared with the areas where the membrane 28 is fused to the induction board 10. In another embodiment, the roof system can be used to partially adhere the membrane 28 with the induction board 10. In such an embodiment, it may not be necessary to fully adhere the roof, by way of example, where the roof may not experience high wind forces or other weather events. Furthermore in an embodiment, the roof system 18 may be a combination of a fully adhered roof and a partially adhered roof.

Thus, the roof system 18 as described herein may provide flexibility during the roof installation. That is, the membrane 28 may be fully adhered to the induction board 10 over all or some of the roof deck 20 and it may be partially adhered to the induction board 10 over other parts of the roof deck 20. In an embodiment, the membrane 28 may be partially adhered to the induction board such that the membrane 28 is not adhered over portions of the roof deck. Using a metal wire 14 and particularly a metal wire mesh may increase the hail resistance of the roof system 18. In addition the roof system 18 may decrease the labor time necessary to install the roof system 18 to the roof deck. There may be a reduction in the number of mechanical fasteners 22 that may be needed. Further, the roof system 18 substantially reduces, if not eliminates mechanical fastener penetration of the membrane 28. In addition, the roof system 18 may provide a more consistent application of adhesive 16 to the membrane 28 which may result in more consistent adhesion of the membrane 28 to the induction board 10

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “by way of example,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. An induction board for use in a roofing application comprising:
a base material;
metal wire disposed over the base material wherein the metal wire is configured to act as a susceptor for an induction welding process;
an adhesive disposed over the base material, wherein the metal wire is coated with the adhesive and wherein the adhesive is thermally activated.

2. An induction board as set forth in claim 1 wherein the metal wire is in the form of metal wire mesh.

3. An induction board as set forth in claim 2 wherein the metal wire mesh is laminated to one side of the base material and the adhesive is disposed over the base material and the metal wire mesh.

4. An induction board as set forth in claim 2 wherein the base material rigid or semi-rigid.

5. An induction board as set forth in claim 4 wherein the base is a coverboard.

6. An induction board as set forth in claim 5 wherein the coverboard comprises recycled material.

7. An induction board as set forth in claim 4 wherein the base material comprises insulation.

8. An induction board as set forth in claim 7 wherein the insulation comprises standard or high density polyisocyanurate.

9. A roof system comprising:
an induction board secured to a roof deck comprising a base material, metal wire configured to act as a susceptor for an induction welding process disposed over the base material and an adhesive disposed over the base material, wherein the metal wire is coated with a thermally activated adhesive;
a membrane disposed over the induction board, wherein the membrane is adhered to the base by the thermally activated adhesive.

10. A roof system as set forth in claim 9 wherein the metal wire is in the form of metal wire mesh.

11. A roof system as set forth in claim 9 wherein the base comprises coverboard.

12. A roof system as set forth in claim 9 wherein the base comprises insulation.

13. A roof system as set forth in claim 9 wherein the membrane is fully adhered to the induction board.

14. A roof system as set forth in claim 9 wherein the membrane is partially adhered to the induction board.
